(19) United States
(12) Patent Application Publication
(10) Pub. No.: US 2023/0008971 A1
(43) Pub. Date: Jan. 12, 2023

(54) METHODS AND SYSTEMS RELATING TO IMPROVEMENTS IN RELIABILITY OF FLUID POWER ACTUATORS

(71) Applicant: Shailesh SHARMA, Pune (IN)

(72) Inventor: Shailesh SHARMA, Pune (IN)

(21) Appl. No.: 17/782,120

(22) PCT Filed: Dec. 2, 2020
(86) PCT No.: PCT/IN2020/050994

§ 371 Date: Jun. 2, 2022

(30) Foreign Application Priority Data
Dec. 2, 2019 (IN) 201921049425

(51) Int. Cl. F15B 15/06; F15B 15/20; F15B 15/14

(52) U.S. Cl. CPC F15B 15/066; F15B 15/20; F15B 15/149

(57) ABSTRACT

Methods and systems relating to improvements in reliability of fluid power actuators are disclosed. An exemplary fluid power actuator (300) comprises, an actuator body (305) having a cylindrical cavity (310), fitted with a first end cap (315) and a second end cap (320) at longitudinal ends, a piston (325) with a piston rod (330) disposed inside the cylindrical cavity (310), wherein the actuator (300) is characterised by, a hollow tie rod (335) in the cylindrical cavity (310), wherein the hollow tie rod (335) is for conveying a pressurised fluid into a volume (A) in the cylindrical cavity (310) between the second end cap (320) and the piston (325) for exerting a force on the piston (325) for a stroke or stroke reversal. The hollow tie rod 335 serves dual purpose of holding the pressure retaining components together, providing a flow path for the fluid enabling actuator stroking and stroke reversal.

### PRIORITY

This patent application claims priority from the Indian provisional Patent Application No. 201921049425 filed on Dec. 2, 2019.

### FIELD OF THE DISCLOSURE

The present disclosure generally relates fluid power actuators and more particularly relates to methods and systems relating to improvements in reliability of fluid power actuators.

### BACKGROUND OF THE DISCLOSURE

Generally, fluid power actuators receive a fluid (gas or liquid) from a compressor or a pump, typically driven by an electric motor. The pressure, flow, and direction of flow of the fluid are controlled and the fluid either enters into and/or exits an actuator for the actuator to convert the fluid's energy into rotary or linear motion for the purpose of doing a useful work. FIG. 1A and FIG. 1B illustrates operations of a conventional double acting actuator and a single acting actuator. As shown in FIG. 1A conventional double acting fluid power actuators (linear and rotary), use the force exerted by a pressurized fluid (gas or liquid) on the area of the piston (105), to move the piston (105) in the direction of the applied force and the fluid present on the other side of the piston is allowed to escape. To reverse the actuator stroke, the pressurized fluid is applied on the area of the piston (105) in the opposite direction. Conventional single acting (spring return) actuators shown in FIG. 1B use force exerted by pressurized fluid on the piston (110) to move the piston in the direction of the applied force. Some amount of this force is stored as potential energy, in a spring module or an accumulator module. To reverse the actuator stroke, the stored potential energy (from the spring or accumulator module) is applied on the piston (110) in the opposite direction and fluid present in the actuator is allowed to escape, enabling actuator stroke reversal. The state of the art or conventional fluid power actuators have various drawbacks and there has been a long felt need for improving their reliability, make the actuators easier and less expensive to manufacture, assemble, commission, and service as well as making them resistant to tampering.

Conventional double acting and single acting actuators use tapped holes on end caps to allow pressurized fluid to enter the actuator and exert a force on a piston to move the piston in the direction of the force. The fluid present on the opposite side of the piston exits the actuator through the tapped hole on the end-cap. To reverse the motion, pressurized fluid is applied in the opposite direction, on the other side of the piston, in case of double acting actuators. On the other hand, the single acting actuators use potential energy of a spring or an accumulator system to reverse the piston motion and the fluid present in the actuator is allowed to escape through the tapped hole, enabling actuator stroke reversal.

Conventional fluid circuit logic for operating the actuator in two mutually opposite directions requires external tubing and fittings at each end or side of actuator, connected to a direction control valve to enable stroke and stroke reversal. For example, 5/2 or 4/2 valves for double acting actuators and 3/2 valve for single acting actuators. The external tubing, on both the sides of the actuator, for making the fluid to enter and exit the actuator creates one or more problems. FIG. 2 shows a conventional double acting actuator and single acting actuator with tubing fittings and accessories for stroking and stroke reversal.

Some rack and pinion actuators and scotch yoke actuators use a central NAMUR (User Association of Automation Technology in Process Industries) pattern on the actuator body to directly introduce pressurized fluid in one side on piston, and drill a hole in the body of the actuator to transfer pressurized fluid through the end caps to the other side of the piston. Some other rack and pinion actuators use a NAMUR pattern on the actuator end cap and two hollow rods, one each, to transfer pressurized fluid to each side of the piston. One rod is used to directly introduce pressurized fluid in one side on piston, and the other rod to transfer pressurized fluid to the other side of the piston.

Described, conventional fluid power actuators have various drawbacks in terms of their design, structure, operations, efficiency, etc., and few are listed below.
Conventional fluid power actuators (linear, rotary, single acting and double acting actuators) use drilled, tapped holes in end caps for fluid entry and exit, and use external tubing, fittings and solenoid valves for stroke reversal. This requires skilled workers, tools and time during assembly of external tubing and fittings.
External tubing and fittings introduce multiple joints in the actuator assembly. These are potential and primary leakage paths for the pressurized fluid, and require careful and regular checks for leak tightness during assembly and after installation. Need regular checks and maintenance.
Leakage through external tubing and fittings in an actuator cause loss of fluid and reduction in Torque/Thrust of the actuator, and/or may stop actuator operation completely in case of double-acting actuators. In case of spring return actuators, this leakage may cause reduction in torque/thrust and/or may result in a spurious trip (closing and opening). Further, this may lead to change in valve position in single acting actuators and/or increase in actuator operating time for single acting and double acting actuators.
Conventional fluid power actuators having external tubing and fittings are expensive, require space as the external tubing and fittings protrude out of the actuator assembly, and require careful handling during packing, transportation, installation and commissioning.
External tubing and fittings assembly of the conventional actuators are exposed in the plant and may be susceptible to unintentional damage, cutting, tampering, and sabotage by unauthorized personnel, thereby posing a risk/safety hazard to the process, humans, plant and equipment functionality.
In conventional fluid power actuators, the external tie rods and external tie rod nuts are exposed to the environment. This may reduce the life of such components due to prolonged exposure to the environment. Environmental exposure causes rusting, oxidation and deterioration of these components. This poses a risk of failure over prolonged use and makes disassembly and reassembly of actuators difficult.
Even though few actuators are equipped with internal tie rods, such designs use threaded tie rods, tie rod nuts and the threaded portion of the tie rod and tie rod nuts are exposed to the environment. This exposure may lead to tampering, rusting, oxidation and deterioration of these components. Further, loosening of (tie rod, tie rod nuts) components, holding the pressurized cylinder assembly together, may be a severe safety hazard, may result in injury to personnel and damage to plant machinery and equipment. Further, loosening of pressure retaining components (tie rod, tie rod nuts) may cause (reduction in torque/thrust) and may cause a spurious trip or change in actuator/valve position causing disturbance in the process.
Actuators having end caps screwed or welded to the cylinder makes the equipment hard to service and require special tools, expertise during servicing. Further, such actuators do require external tubing and fittings.

As described, some rack and pinion and scotch yoke rotary actuator use a central NAAMUR Pattern to directly introduce pressurized fluid in one side on piston, and drill a hole in the body of the actuator to transfer pressurized fluid to the other side of the piston. However, such fluid power actuators do have following drawbacks.
The design limits the speed of stroke of the actuator which is defined by the size of hole drilled in the actuator body.
Operational speed of the actuator cannot be changed as it is not possible to change the size of hole in actuator body at a site installation. Further, addition machining (drilling) is required on both the body and the end caps to enlarge the fluid path to improve speeds of operation.

As described, the state of the art or conventional fluid power actuators have various drawbacks and there has been a long felt need for improving their reliability, make the actuators easier and less expensive to manufacture, assemble, commission, and service as well as making them resistant to tampering.

### BRIEF SUMMARY OF THE DISCLOSURE

This summary is provided to introduce a selection of concepts in a simple manner that is further described in the detailed description of the disclosure. This summary is not intended to identify key or essential inventive concepts of the subject matter nor is it intended for determining the scope of the disclosure.

Methods and systems relating to improvements in reliability of fluid power actuators are disclosed. An exemplary fluid power actuator comprises, an actuator body having a cylindrical cavity, wherein a major axis of the cylindrical cavity is substantially parallel to a longitudinal axis of the actuator body, wherein the actuator body is fitted with a first end cap and a second end cap at longitudinal ends of the actuator body and a piston with a piston rod disposed inside the cylindrical cavity, the piston being free to move along the longitudinal axis of the cylindrical cavity, wherein the actuator is further characterised by, a hollow tie rod in the cylindrical cavity, wherein the hollow tie rod is used for conveying a pressurised fluid into a volume in the cylindrical cavity between the second end cap and the piston for exerting a force on the piston for one of a stroke and a stroke reversal. The hollow tie rod serves dual purpose of holding the pressure retaining components together and providing a flow path for the fluid enabling actuator stroking and stroke reversal.

Further, linear double acting fluid power actuator, linear spring return fluid power actuator, rotary scotch yoke double acting fluid power actuator and rotary scotch yoke single acting fluid power actuator having internal hollow tie rods serving dual purpose of holding the pressure retaining components together and providing a flow path for the fluid enabling actuator stroking and stroke reversal is disclosed.

To further clarify advantages and features of the present disclosure, a more particular description of the disclosure will be rendered by reference to specific embodiments thereof, which is illustrated in the appended figures. It is to be appreciated that these figures depict only typical embodiments of the disclosure and are therefore not to be considered limiting of its scope. The disclosure will be described and explained with additional specificity and detail with the accompanying figures.

### BRIEF DESCRIPTION OF THE FIGURES

The disclosure will be described and explained with additional specificity and detail with the accompanying figures in which:

FIG. 1A and FIG. 1B illustrates operations of a conventional double acting actuator and a single acting actuator;

FIG. 2 shows a conventional double acting actuator and single acting actuator with tubing fittings and accessories for stroking and stroke reversal;

FIG. 3 illustrates a linear double acting fluid power actuator with internal hollow tie rod in accordance with an embodiment of the present disclosure;

FIG. 4A illustrates a linear spring return fluid power actuator (spring to extend) with internal hollow tie rod in accordance with an embodiment of the present disclosure;

FIG. 4B illustrates a linear spring return fluid power actuator (spring to retract) with internal hollow tie rod in accordance with an embodiment of the present disclosure;

FIG. 5A illustrates a rotary scotch yoke double acting fluid power actuator with internal hollow tie rod in accordance with an embodiment of the present disclosure;

FIG. 5B illustrates a rotary scotch yoke single acting fluid power actuator with spring module for stroke reversal in accordance with an embodiment of the present disclosure;

FIG. 5C specifically illustrates a spring module of the rotary scotch yoke single acting fluid power actuator in accordance with an embodiment of the present disclosure; and

FIG. 6 illustrates a rotary scotch yoke fluid power actuator with multi-misalignment absorption mechanism in accordance with an embodiment of the present disclosure.

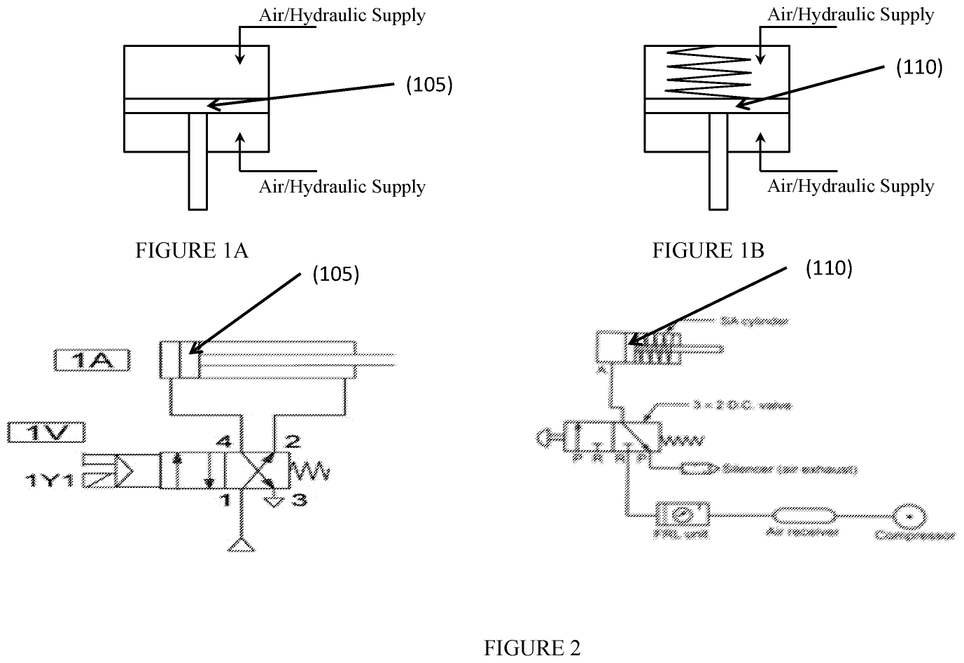

Further, persons skilled in the art to which this disclosure belongs will appreciate that elements in the figures are illustrated for simplicity and may not have been necessarily drawn to scale. Furthermore, and the figures may show only those specific details that are pertinent to understanding the embodiments of the present disclosure so as not to obscure the figures with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will be understood by those skilled in the art that the foregoing general description and the following detailed description are exemplary and explanatory of the disclosure and are not intended to be restrictive thereof.

In the present disclosure, relational terms such as first and second, and the like, may be used to distinguish one entity from the other, without necessarily implying any actual relationship or order between such entities.

The terms “comprises”, “comprising”, or any other variations thereof, are intended to cover a non-exclusive inclusion, such that a process or method that comprises a list of steps does not include only those steps but may include other steps not expressly listed or inherent to such a process or a method. Similarly, one or more elements or structures or components preceded by “comprises . . . a” does not, without more constraints, preclude the existence of other elements, other structures, other components, additional devices, additional elements, additional structures, or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The components, methods, and examples provided herein are illustrative only and not intended to be limiting.

The present disclosure related to methods and systems relating to improvements in reliability of fluid power actuators, the fluid power actuators including single acting linear actuators, double acting linear actuators, rotary scotch yoke double acting actuators and rotary scotch yoke single acting actuators. Generally, a fluid power actuator comprises an actuator body having a cylindrical cavity with its major axis substantially parallel to a longitudinal axis of the actuator body, a first end cap and a second end cap at longitudinal ends of the actuator body, and a piston disposed inside the hollow cylinder, the piston being displaceable along the longitudinal axis of the cylindrical cavity. In one embodiment of the present disclosure, the fluid power actuator of the present disclosure further comprises at least one hollow tie rod inside the cylindrical cavity, wherein the hollow tie rod is used for conveying a pressurized fluid into a volume in the cylindrical cavity between the second end cap and the piston for exerting a force on the piston for one of a stroke and a stroke reversal.

In one embodiment of the present disclosure, a first end of the hollow tie rod is screwed to the first end cap and passes through the first end cap, piston, second end cap, and a second end of the hollow tie rod is fastened to the second end cap with a nut for conveying the pressurized fluid and for holding the two end caps to the actuator body. Hence, the system having the hollow tie rod along with one or more tie rods inside the cylindrical cavity of the fluid power actuator holds the pressure retaining cylinder assembly (cylinder, two end caps and the piston). In one embodiment, the one or more tie rods may be solid tie rods or hollow tie rods or combination of both. The manner in which the different types of fluid power actuators, having hollow tie rod positioned inside the cylindrical cavity, functions is described in detail further below in the present disclosure.

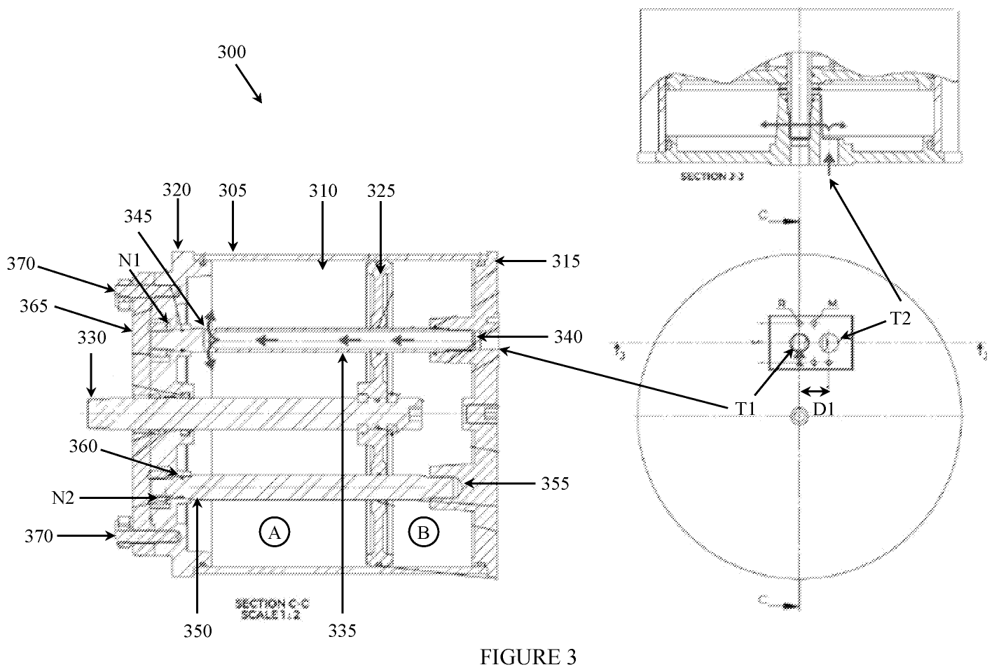

FIG. 3 illustrates a linear double acting fluid power actuator with internal hollow tie rod in accordance with an embodiment of the present disclosure. As shown, the linear double acting fluid power actuator 300 comprises an actuator body, 305 having a cylindrical cavity 310, a first end cap 315, a second end cap 320, a piston 325 with a piston rod 330, and a hollow tie rod 335.

As shown, a major axis of the cylindrical cavity 310 is substantially parallel to a longitudinal axis of the actuator body 305, and the actuator body 305 is fitted with the first end cap 315 and the second end cap 320 at longitudinal ends of the actuator body 305. It is to be noted that the actuator body 305, the first cap 315 and the second end cap 320 are made of steel, ductile iron or metal alloys or non-metals having similar properties. Further, the piston 325 with piston the piston rod 330 is disposed inside the cylindrical cavity 310 and disposed so as to move along the longitudinal axis of the cylindrical cavity 310 when a force is applied on one of the side of the piston 325. In a preferred embodiment, the piston 325 is made of ductile iron or steel or metal alloys or non-metals having similar properties, piston rod 330 is made of alloy steel, and the piston assembly comprises other components such as but not limited to piston X-ring, piston rod O-ring, and piston sealing set, preferably made of Nitrile Rubber (NBR) or other suitable compounds such as Viton, for example. A person skilled in the art having access to this closure will be able to select a suitable material.

In one embodiment of the present disclosure, the hollow tie rod 335 passes through the piston 325, a first end 340 of the hollow tie rod 335 is screwed to the first end cap 315 and passes through the first end cap 315, and a second end 345 of the hollow tie rod 335 passes through second end cap 320 and is fastened to the second end cap 320 with a nut N1 for holding the two end caps 315 and 320 to the actuator body 305. Further, the first end 340 of the hollow tie rod 335 is coupled to a first port T1, wherein the first port T1 is configured for feeding a pressurized fluid through hollow tie rod 335 into a volume A in the cylindrical cavity 310 between the second end cap 320 and the piston 325, and for draining the pressurized fluid from the volume A between the second end cap 320 and the piston 325. That is, in one embodiment of the present disclosure, the hollow tie rod 335 is used for conveying the pressurised fluid into the volume A in the cylindrical cavity 310 between the second end cap 320 and the piston 325 for exerting a force on the piston 325 for one of a stroke and a stroke reversal. As described, the pressurised fluid is fed to the hollow tie rod 335 through the port T1 and the pressurized fluid is received from a reservoir through a pump, the pump typically driven by an electric motor, as well known in the art.

In one embodiment of the present disclosure, the linear double acting fluid power actuator 300 comprises one or more tie rods 350 (shown one tie rod in FIG. 3) inside the cylindrical cavity 310, in addition to the hollow tie rod 335, for holding the two end caps 315 and 320 to the actuator body 305. It is to be noted that the one or more tie rods 350 may include one of a solid tie rods and hollow tie rods and combination thereof. Further, similar to the hollow tie rod 335, a first end 355 of each of the one or more tie rods 350 is screwed into the first end cap 315 and a second end 360 of each of the one or more tie rods 350 is fastened to the second end cap 320 with nut(s) N2 for holding the two end caps 315 and 320 to the actuator body 305. In a preferred embodiment, the hollow tie rod 335 and the one or more other tie rods 350 are made of alloy steel. Further, it is to be noted that the tie rods 335 and 350 passes through the piston 325 and tie rod O-ring made of Nitrile Rubber (NBR) or any other suitable compound, as explained earlier, and it enables movement of the piston 325 over the tie rods 335 and 350.

Further, in one embodiment of the present disclosure, the first end cap 315 comprises a second port T2 configured for feeding the pressurised fluid into a volume B in the cylindrical cavity 310 between the first end cap 315 and the piston 325, and for draining the pressurised fluid from the volume B between the first end cap 315 and the piston 325. As described and shown in FIG. 3, the linear double acting fluid power actuator 300 disclosed in the present disclosure comprises two ports T1 and T2 on the first end cap 315 and the distance D1 between the two ports T1 and T2 are designed so as to allow the use of NAMUR mounted solenoid valves for the stroke and stroke reversal, and further eliminates the need of external tubing and reduces the number of fittings for stroke and stroke reversal in the linear fluid power actuators. The manner in which the linear double acting fluid power actuator 300 operates is described in detail further below.

Referring to FIG. 3 when the pressurized fluid is introduced in port T1, the pressurized fluid passes through the hollow tie rod 335 into the volume A in the cylindrical cavity 310 between the second end cap 320 and the piston 325 and exerts a force on the piston 325, causing the piston 325 to move towards the first end cap 315. The fluid present on the other side, that is, in the volume B in the cylindrical cavity 310 between the first end cap 315 and the piston 325, is drained or exhausted through the port T2. The force exerted on the piston 325 in linear actuator causes actuator to stroke, causing retraction of the piston rod 330. During actuator stroke reversal, the pressurized fluid is introduced to the volume B in the in the cylindrical cavity 310 between the first end cap 315 and the piston 325 through the port T2. The pressurized fluid entering through the port T2 exerts a force on the piston 325 causing the piston 325 to move towards the second end cap 320. The fluid present in the volume A between the second end cap 320 and the piston 325, on the other side of the piston 325, is exhausted through the hollow tie rod 335 to the port T1. The force exerted on the piston 325 in linear actuator causes stroke reversal, causing extension of the piston rod 330. In one exemplary implementation, the fluid pressure and flow for stroke and stroke reversal is controlled using pressurized fluid and NAMUR mounted solenoid valve on ports T1 and port T2. As described, the hollow tie rod 335 along with one or more tie rods 350 holds two end caps 315 and 320 to the actuator body 305. Further, the hollow tie rod 335 provides a path for transferring or exhausting or draining the fluid, for stroke and stroke reversal, that is for moving (extending and retracting) the piston rod 330. Hence, the hollow tie rod 335 serves dual purpose of holding the pressure retaining components together and providing a flow path for the fluid enabling actuator stroking and stroke reversal. The two ports T1 and T2 on the first end cap 315 and the distance D1 between the two ports T1 and T2 are designed so as to allow the use of NAMUR mounted solenoid valves for the stroke and stroke reversal, and further eliminates the need of external tubing and reduces the number of fittings for stroke and stroke reversal in the linear fluid power actuators. The Namur Solenoid placed on port T1 and T2 along with the hollow tie rod 335 eliminates the need of providing tapped holes on each end cap 315 and 320, external fittings on these holes and external tubing for actuator stroking and stroke reversal.

As described, fluid power is used for stroke and stroke reversal in the linear double acting fluid power actuator 300. Alternatively, a spring may be used in two ways for stroke reversal in linear fluid power actuators. The manner in which the hollow tie rod and spring is used for stroke and stroke reversal in a linear fluid power actuator is described in detail further below.

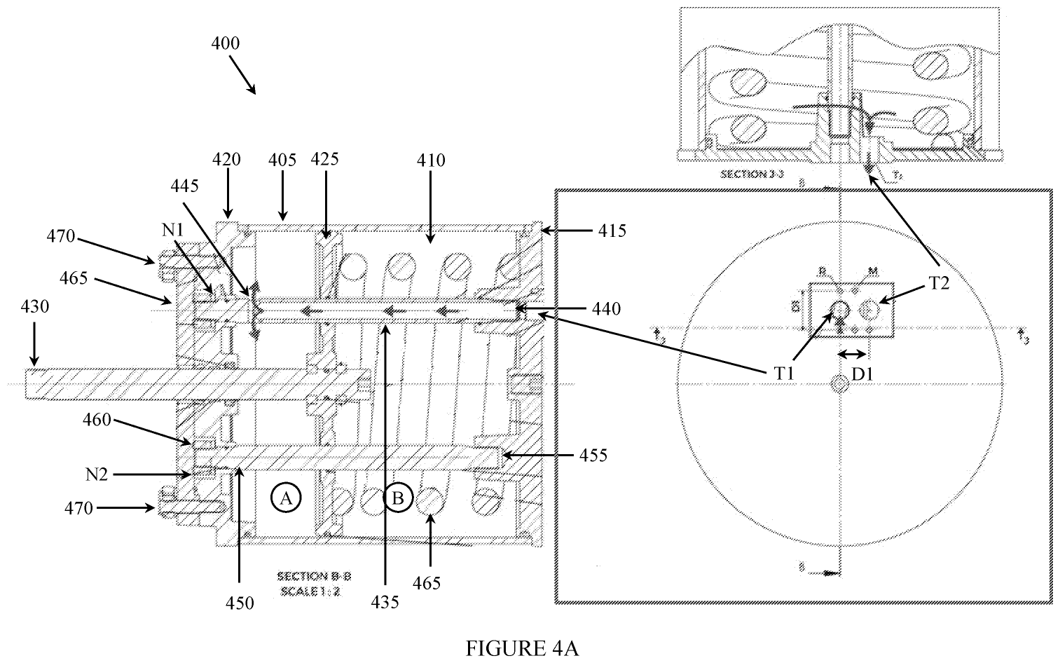

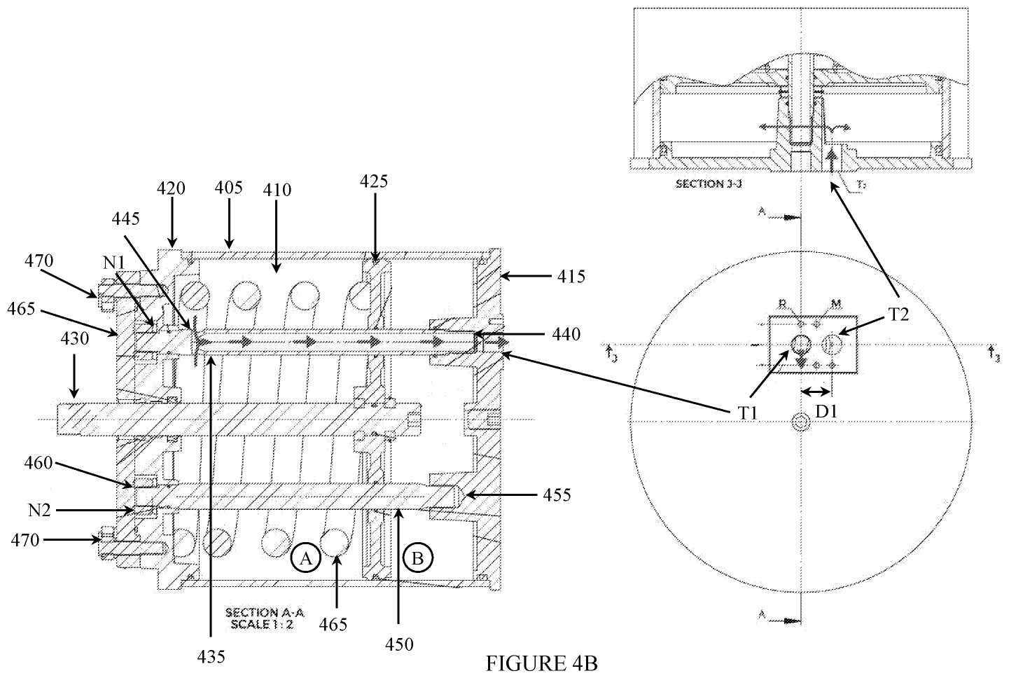

FIG. 4A illustrates a linear spring return fluid power actuator (spring to extend) with internal hollow tie rod in accordance with an embodiment of the present disclosure. As shown, the linear spring return fluid power actuator 400 comprises (hereafter referred to as spring return actuator 400) an actuator body 405 having a cylindrical cavity 410, a first end cap 415, a second end cap 420, a piston 425 with a piston rod 430, a hollow tie rod 435 and a spring 465, preferably made of alloy steel. As shown, the spring 465 is disposed in a volume B, in the cylindrical cavity, between the first end cap 415 and the piston 425 for reversing the stroke during the operation. That is, the spring 465 is used for extension of the piston rod 430.

It is to be noted that the first end cap 415, the second end cap 420, and the piston 425 with piston rod 430 are manufactured assembled, and disposed in a similar fashion as that of the linear double acting fluid power actuator 300. Also, the spring return actuator 400 comprises one or more tie rods 450 (shown one tie rod) inside the cylindrical cavity 410, in addition to the hollow tie rod 435, for holding the two end caps 415 and 420 to the actuator body 405. It is to be noted that the tie rods 435 and 450 are made of same material and disposed in a similar fashion as the tie rods of the linear double acting fluid power actuator 300, disclosed with reference to FIG. 3.

Further, similar to the linear double acting fluid power actuator 300 (shown in FIG. 3), the hollow tie rod 435 passes through the piston 425, a first end 440 of the hollow tie rod 435 is screwed to the first end cap 415 and passes through the first end cap 415, and a second end 445 of the hollow tie rod 435 passes through second end cap 420 and is fastened to the second end cap 420 with a nut N1 for holding the two end caps 415 and 420 to the actuator body 405. Furthermore, the first end 440 of the hollow tie rod 435 is coupled to a first port T1, wherein the first port T1 is configured for feeding a pressurized fluid through hollow tie rod 435 into a volume A in the cylindrical cavity 410 between the second end cap 420 and the piston 425, and also for draining the pressurized fluid from the volume A between the second end cap 420 and the piston 425. That is, the hollow tie rod 435 is used for conveying the pressurised fluid into the volume A in the cylindrical cavity 410 between the second end cap 420 and the piston 425 for exerting a force on the piston 425 to move the piston 425 towards the first end cap 415 and compressing the spring 465 for causing a stroke. In addition, the first end cap 415 comprises a second port T2 configured for draining the pressurised fluid from a volume B between the first end cap 415 and the piston 420 during the stroke. During stroke reversal the compressed spring 465 exerts a force on the piston 425 causing it to move towards second end cap 420. During stroke reversal, the fluid enters the expanding cavity B (volume B) through port T2 and the fluid present in contracting cavity A (volume A) is drained through the hollow tie rod 435 to port T1. The two ports T1 and T2 on the first end cap 415 and the distance D1 between the two ports T1 and T2 are designed so as to allow the use of NAMUR mounted solenoid valves for the stroke and stroke reversal, and further eliminates the need of external tubing and reduces the number of fittings for stroke and stroke reversal in the linear fluid power actuators. The manner in which the spring return actuator 400 operates is described in detail further below.

Referring back to FIG. 4A when the pressurized fluid is introduced in port T1, the pressurized fluid passes through the hollow tie rod 435 to the volume A in the cylindrical cavity 410 between the second end cap 420 and the piston 425 and exerts a force on the piston 425, causing the piston 425 to move towards the first end cap 415. The fluid present on the other side, that is in the cylindrical cavity 410 in volume B (between the first end cap 415 and the piston 425), is drained or exhausted through the port T2. The force exerted on the piston 425 in linear actuator causes actuator to stroke, causing retraction of the piston rod 430. Further, part of the force exerted on the piston 425 is stored as potential energy in the spring 465 (accumulator module), that is, the spring 465 is compressed against the first end cap 415. The potential energy stored in the spring 465 exerts a force on the piston 425 causing the piston 425 to move toward the second end cap 420, causing the actuator stroke reversal. This causes extension of the piston rod 430. That is, during stroke reversal, the potential energy from the expanding spring 645 exerts a force on the piston 425, causing the piston 425 to move towards the second end cap 420 and hence the extension of the piston rod 430. Further, during stroke reversal, the fluid is sucked from port T2 into the volume B in the cylindrical cavity 410 between the first end cap 415 and the piston 425. Furthermore, the pressurized fluid, enclosed in the volume A in the cylindrical cavity 410 between the second end cap 420 and the piston 425, passes through the hollow tie rod 435 and exhausted or drained through the port T1.

As described, in one embodiment of the present disclosure, the fluid power is used for stroke and spring 465 is used for stroke reversal in the spring return actuator 400. In another embodiment of the present disclosure, the spring 465 is disposed in a volume A, in the cylindrical cavity 410 between the second end cap 420 and the piston 425, for reversing the stroke during the operation. FIG. 4B illustrates a linear spring return fluid power actuator (spring to retract) with internal hollow tie rod in accordance with an embodiment of the present disclosure. As shown, the spring 465 is disposed in a volume A, in the cylindrical cavity 410, between the second end cap 420 and the piston 425 for reversing the stroke during the operation. That is, the spring 465 is used for retraction of the piston rod 430. The manner in which the spring return actuator 400 (spring to retract) functions is described in detail further below.

Referring to FIG. 4B, the pressurized fluid is directly introduced through the port T2 into the volume B, in the cylindrical cavity 410 (in volume B) between the first end cap 415 and the piston 425. The pressurized fluid exerts a force on the piston 425, causing the piston 425 to move towards the second end cap 420, the stroke. This causes extension of the piston rod 430. Further, the fluid present on the other side, that is, in the volume A in the cylindrical cavity 410 between the first end cap 415 and the piston 425, passes through the hollow tie rod 435 and is drained or exhausted through the port T1 (shown by the arrow lines). Further, the force exerted on the piston 425 compresses the spring 465 against the second end cap 420.

During actuator stroke reversal, the potential from the expanding spring 465 exerts a force on the piston 425 causing the piston 425 to move towards first end cap 415 and retracts the piston rod 430. During this, the fluid is sucked from the port T1 through the hollow tie rod 435 into the volume A in the cylindrical cavity 410 between the piston 425 and the second end cap 420. At the same time, the fluid enclosed in the volume B is exhausted or drained through the port T2 causing the spring 465 to move the piston 425 toward the first end cap 415 and the retraction of the piston rod 430. Similar to the linear double acting fluid power actuator 300, the fluid pressure and flow for stroke and stroke reversal is controlled using pressurized fluid and NAMUR mounted solenoid valve on port T1 and port T2.

In one embodiment of the present disclosure, the second end cap of the linear fluid power actuator is covered with an end plate for concealing the second end cap so as to restrict access to the nuts, making the assembly tamperproof. Referring to FIG. 3, the second end cap 320 is covered with an end plate 365 using washers and nuts 370. The end plate 365 covers the tie rods 335 and 350, and the tie rod nuts N1 and N2, and hence protects from oxidation, rusting and material deterioration due to environmental exposure and further restricts access to the assembly eliminating tampering, loosing of nuts, etc. Referring to FIGS. 4A and 4B, the second end cap 420 is covered with an end plate 465 using washers and nuts 470 for protecting the tie rods 435 and 450, and the tie rod nuts N1 and N2 from environmental exposure and unauthorized or accidental tampering.

As described, fluid power is used for stroke and stroke reversal in the linear double acting fluid power actuator 300, and the fluid power and potential energy stored in the spring 465 is used for stroke and stroke reversal in linear single acting fluid power actuators. In both the double acting and single acting fluid power actuators, the ports T1 and T2 are designed so as to allow the use of NAMUR mounted solenoid valves for the stroke and stroke reversal. In addition, the hollow tie rod, which is used for conveying the fluid and for holding the two end caps, eliminates the need of external tubing and reduces the number of fittings for stroke and stroke reversal in the linear fluid power actuators. In a similar way as that of the linear fluid power actuators, the hollow tie rod and elements are used in rotary scotch yoke actuators for eliminating the need of external tubing and for reducing the number of fittings for stroke and stroke reversal.

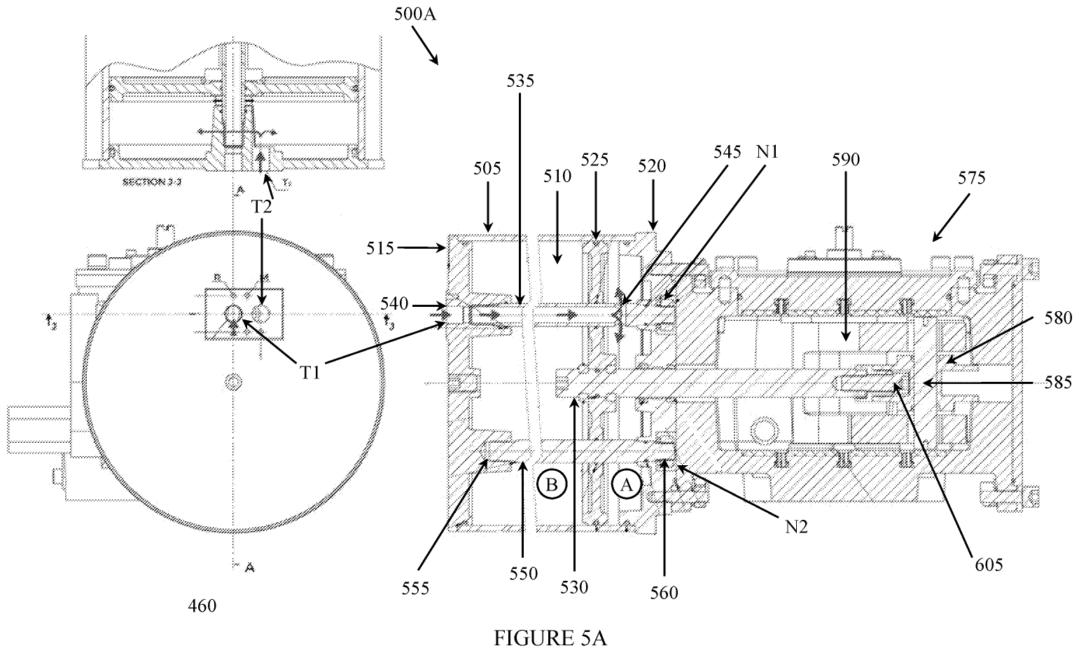

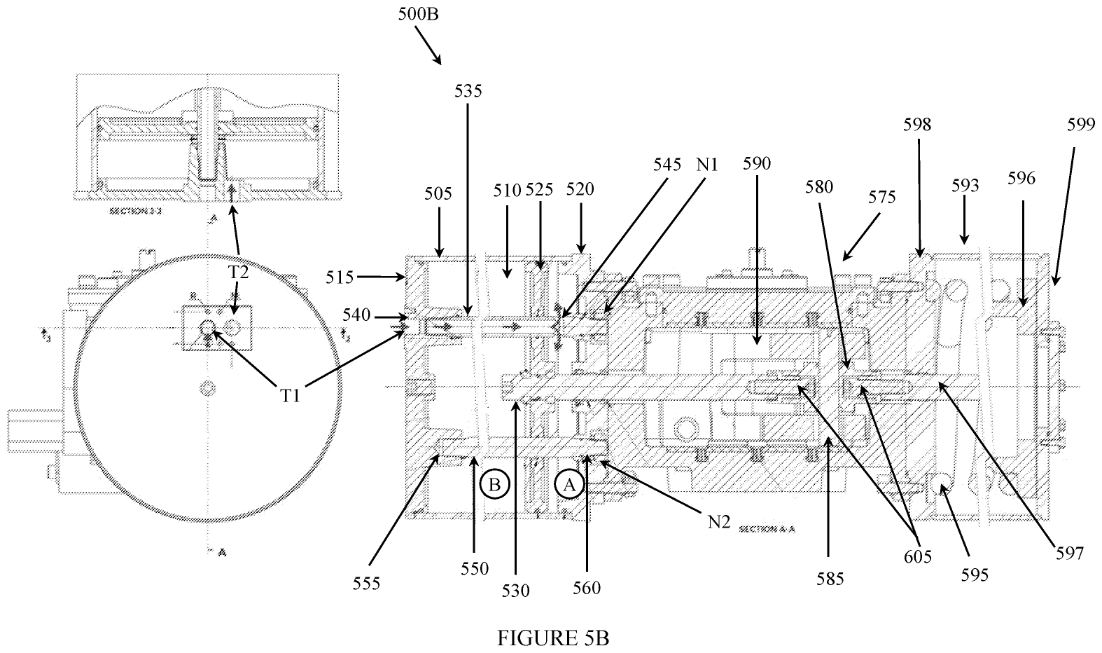

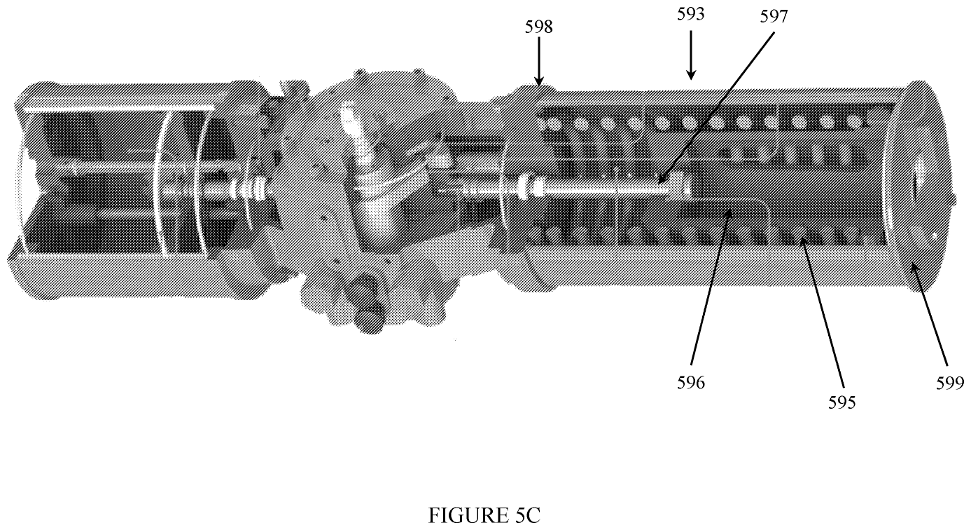

FIG. 5A illustrates a rotary scotch yoke double acting fluid power actuator with internal hollow tie rod in accordance with an embodiment of the present disclosure. Similar to the linear power actuators, the rotary scotch yoke double acting fluid power actuator 500A comprises an actuator body 505 having a cylindrical cavity 510, a first end cap 515, a second end cap 520, a piston 525 with a piston rod 530, and a hollow tie rod 535. In addition, the rotary scotch yoke double acting fluid power actuator 500A includes a yoke module 575 for converting a linear motion to a rotary motion of a yoke in one of a clockwise direction and an anti-clockwise direction.

As shown, a major axis of the cylindrical cavity 510 is substantially parallel to a longitudinal axis of the actuator body 505, and the actuator body 505 is fitted with the first end cap 515 and the second end cap 520 at longitudinal ends of the actuator body 505. It is to be noted that the actuator body 505, the first cap 515 and the second end cap 520 are made of ductile iron, steel or metal alloys having similar properties. Further, the piston 525 with piston the piston rod 530 is disposed inside the cylindrical cavity 510 and disposed so as to move along the longitudinal axis of the cylindrical cavity 510 when a force is applied on one of the side of the piston 525. In a preferred embodiment, the piston 525 is made of ductile iron, steel, piston rod 530 is made of steel, alloy steel, and the piston assembly comprises other components such as but not limited to piston X-ring, O-Ring, piston rod O-ring, and piston sealing set, preferably made of Nitrile Rubber (NBR) or any other compound, as explained earlier.

In one embodiment of the present disclosure, the hollow tie rod 535 passes through the piston 525, a first end 540 of the hollow tie rod 535 is screwed to the first end cap 515 and passes through the first end cap 515, and a second end 545 of the hollow tie rod 535 passes through the second end cap 520 and is fastened to the second end cap 520 with a nut N1 for holding the two end caps 515 and 520 to the actuator body 505. Further, the first end 540 of the hollow tie rod 535 is coupled to a first port T1, wherein the first port T1 is configured for feeding a pressurized fluid through hollow tie rod 535 into a volume A in the cylindrical cavity 510 between the second end cap 520 and the piston 525, and for draining the pressurized fluid from the volume A between the second end cap 520 and the piston 525. That is, in one embodiment of the present disclosure, the hollow tie rod 535 is used for conveying the pressurised fluid into the volume A in the cylindrical cavity 510 between the second end cap 520 and the piston 525 for exerting a force on the piston 525 for one of a stroke and a stroke reversal. As described, the pressurised fluid is fed to the hollow tie rod 535 through the port T1 and the pressurized fluid is received from a reservoir through a compressor or pump, the compressor or pump, typically driven by an electric motor, as well known in the art.

In one embodiment of the present disclosure, the rotary scotch yoke double acting fluid power actuator 500A comprises one or more tie rods 550 (shown one tie rod in FIG. 5A) inside the cylindrical cavity 510, in addition to the hollow tie rod 535, for holding the two end caps 515 and 520 to the actuator body 505. It is to be noted that the one or more tie rods 550 may include one of a solid tie rods and hollow tie rods and combination thereof. Further, similar to the hollow tie rod 535, each of the one or more tie rods passes through the piston 525, a first end 555 of each of the one or more tie rods 550 is screwed into the first end cap 515 and passes through the first end cap 515, and a second end 560 of each of the one or more tie rods 550 passes through the second end cap 520 and is fastened to the second end cap 520 with nut(s) N2 for holding the two end caps 515 and 520 to the actuator body 505. In a preferred embodiment, the hollow tie rod 535 and the one or more other tie rods 550 are made of alloy steel. Further, it is to be noted that the tie rods 535 and 550 passes through the piston 525 and tie rod O-ring made of Nitrile Rubber (NBR) or any other suitable compound, as explained earlier, enables movement of the piston 525 over the tie rods 535 and 550.

Further, in one embodiment of the present disclosure, the first end cap 515 comprises a second port T2 configured for feeding the pressurised fluid into a volume B in the cylindrical cavity 510 between the first end cap 515 and the piston 525, and for feeding or draining the pressurised fluid from the volume B between the first end cap 515 and the piston 525. As described and shown in FIG. 5A, the the rotary scotch yoke double acting fluid power actuator 500A disclosed in the present disclosure comprises two ports T1 and T2 on the first end cap 515 and the distance D1 between the two ports T1 and T2 are designed so as to allow the use of NAMUR mounted solenoid valve for the stroke and stroke reversal, and further eliminates the need of tapped holes on each of the end caps 515 and 520, external tubing and reduces the number of fittings for stroke and stroke reversal in the rotary scotch yoke fluid power actuators.

As described, the rotary scotch yoke double acting fluid power actuator 500A includes a yoke module 575 for converting a linear motion to a rotary motion of a yoke in one of a clockwise direction and an anti-clockwise direction. In one embodiment of the present disclosure, the yoke module 575 is detachably attached to actuator body 505 through the second end cap 520 by means nuts and bolts as shown, and the yoke module 575 comprises a guide block 580, a yoke pin 585 and a yoke 590, wherein the force exerted on the piston 525 for one of the stroke and the stroke reversal is transferred to the yoke 590 through the piston rod 530, the guide block 580 and the yoke pin 585 for converting the linear motion to a rotary motion of the yoke 590 in one of a clockwise direction and an anti-clockwise direction, when viewed from top. Referring to FIG. 5A, an end of the piston rod 530 (an end distal from the piston 525) is coupled to the guide block 580 which is coupled to the yoke pin 585, and linear movement of the piston rod 530 is converted to rotary motion of the yoke 590. The manner in which the rotary scotch yoke double acting fluid power actuator 500A operates is described in detail further below.

Referring to FIG. 5A, when the pressurized fluid is introduced in port T1, the pressurized fluid passes through the hollow tie rod 535 into the volume A in the cylindrical cavity 510 between the second end cap 520 and the piston 525 and exerts a force on the piston 525, causing the piston 525 to move towards the first end cap 515. The fluid present on the other side, that is, in volume B in the cylindrical cavity 510 between the first end cap 515 and the piston 525, is drained or exhausted through the port T2. The force exerted on the piston 525 and the piston rod 530 is transferred to the yoke 590 through the yoke pin 585 and the guide block 580 for rotating the yoke 590 in clockwise direction, when viewed from top. In other words, the force exerted on the piston 525 causes retraction of the piston rod 530 and rotation of the yoke 590 is clockwise direction, when viewed from top. Furthermore, the piston rod 530 is detachably attached to guide block 580 using a unique bolting mechanism 605 designed to take care of misalignments and side loading.

During actuator stroke reversal, the pressurized fluid is introduced to the volume B in the cylindrical cavity 510 between the first end cap 515 and the piston 525 through the port T2. The pressurized fluid entering through the port T2 exerts a force on the piston 525 causing the piston 525 to move towards the second end cap 520. The fluid present in the volume A between the second end cap 520 and the piston 525, on the other side of the piston 525, is exhausted through the hollow tie rod 535 to the port T1. The force exerted on the piston 525 causes extension of the piston rod 530 and anti-clockwise rotation of the yoke 590 through the yoke pin 585 and the guide block 580. It is to be noted that the fluid pressure and flow for stroke and stroke reversal is controlled using pressurized fluid from a compressor or pump and NAMUR mounted solenoid valve in port T1 and port T2. As described, the hollow tie rod 535 along with one or more tie rods 550 holds two end caps 515 and 520 to the actuator body 505. Further, the hollow tie rod 535 provides a path for transferring or exhausting or draining the fluid, for stroke and stroke reversal, that is for moving (retraction and extension) the piston rod 330 and hence for the rotation of yoke 590 in clockwise and anti-clockwise directions. Hence, the hollow tie rod 335 serves dual purpose and eliminates the need of external tubing and fittings.

As described, fluid power is used for stroke and stroke reversal in the rotary scotch yoke double acting fluid power actuator. Alternatively, a spring module may be used for stroke reversal in the rotary scotch yoke fluid power actuators. The manner in which the hollow tie rod and spring module is used for stroke and stroke reversal in a rotary scotch yoke fluid power actuator is described in detail further below.

FIG. 5B illustrates a rotary scotch yoke single acting fluid power actuator with spring module for stroke reversal in accordance with an embodiment of the present disclosure. As shown, the rotary scotch yoke single acting fluid power actuator 500B comprises all the elements of the rotary scotch yoke double acting fluid power actuator 500A (shown in FIG. 5A) and functions in a similar fashion for generating a stroke and hence for rotating the yoke 590 in clockwise direction. In addition to the said elements, the rotary scotch yoke single acting fluid power actuator 500B further comprises a spring module 593, wherein the spring module 593 is detachably attached to the yoke module 575 as shown. Furthermore the Piston Rod 530 and Spring Rod 597 are detachably attached to guide block 580 using a unique bolting mechanisms 605 designed to take care of misalignments and side loading as shown FIG. 5C specifically illustrates a spring module 593 of the rotary scotch yoke single acting fluid power actuator in accordance with an embodiment of the present disclosure. Referring to FIGS. 5B and 5C, the spring module 593 comprises a spring 595, a spring guide 596 and a spring rod 597. One end of the spring rod 597 is coupled to the piston rod through the guide block 580, and the other end of the spring rod is coupled to the spring guide 596 as shown, for transferring the force exerted on the piston 525 to the spring 595. The spring 595 is used for stroke reversal and the manner in which the rotary scotch yoke single acting fluid power actuator 500B functions is described in detail further below with reference to FIGS. 5B and 5C.

Referring to FIGS. 5B and 5C, when the pressurized fluid is introduced in port T1, the pressurized fluid passes through the hollow tie rod 535 into the volume A in the cylindrical cavity 510 between the second end cap 520 and the piston 525 and exerts a force on the piston 525, causing the piston 525 to move towards the first end cap 515. The fluid present on the other side, that is, in volume B in the cylindrical cavity 510 between the first end cap 515 and the piston 525, is drained or exhausted through the port T2. The force exerted on the piston 525 and the piston rod 530 is transferred to the yoke 590 through the yoke pin 585, bolting mechanism 605 and the guide block 580 for rotating the yoke 590 in clockwise direction, when viewed from top. In other words, the force exerted on the piston 525 causes retraction of the piston rod 530 and rotation of the yoke 590 is clockwise direction (when viewed from top). Further, the force exerted on the piston 525 is transferred to the spring rod 597 through the piston rod 530, bolting mechanism 605, guide block 580, and causes compression of the spring 595, against a spring module end cap 598, disposed in a spring module 593, thereby storing the potential energy.

During actuator stroke reversal, the port T1 is opened, causing the pressurized fluid in the volume A between the second end cap 520 and the piston 525 to pass through the hollow tie rod 535 and drained through port T1. At the same time, the potential energy from the expanding spring 595 exerts a force on the spring guide 596 and the spring rod 597, causing the spring rod 597 to move towards an end cap 599 of the spring module 593. The force is further transmitted to the yoke 590 through the yoke pin 585, the bolting mechanism 605, guide block 580, and causes rotation of the yoke 590 in anti-clockwise direction, when viewed from top. Furthermore, the force also causes piston rod 530 to exert a force on the piston 525 causing the piston 525 to move toward the second end cap 520. In other words, during stroke reversal, the potential energy stored in the spring 595 exerts a force on the spring rod 597 and causes anti-clockwise rotation of the yoke 590 (when viewed from top) and extension of the piston rod 530. During this, the fluid is sucked from the port T2 into the volume B in the cylindrical cavity 510 between the piston 525 and the first end cap 515. Similar to the linear fluid power actuator 300 and 400, the fluid pressure and flow for stroke and stroke reversal is controlled using a pressurized fluid from a compressor of pump and NAMUR mounted solenoid valve on port T1 and port T2.

Further, similar to the linear fluid power actuators 300 and 400 disclosed in the present disclosure, the second end cap 520 of the rotary scotch yoke fluid power actuator is concealed so as to restrict access to the nuts, making the assembly tamperproof. Referring to FIGS. 5A and 5B, the yoke module 575 covers the second end cap 520 and protects the tie rods 535 and 550, and the tie rod nuts N1 and N2 from oxidation, rusting and material deterioration due to environmental exposure and further restricts access to the assembly eliminating tampering, loosing of nuts, etc.

As described and shown in FIGS. 5A and 5B, the yoke module 575 is detachably attached to the actuator body 505 through the second end cap 520 and the spring module 593 is detachably attached to the other end of the yoke module 575. Furthermore, the Piston Rod 530 and Spring Rod 597 are detachably attached the guide block 580 by unique bolting mechanism 605 designed to eliminate misalignment and side loading. In such an implementation, the actuator stroke causes clockwise rotation of the yoke 590 (when viewed from top) and the actuator stroke reversal causes anti-clockwise rotation of the yoke 590. In one embodiment, based on the end application, the position may be interchanged, that is, (referring to FIG. 5B), the spring module 593 is attached to the left side of the yoke module 575 and the actuator body 505 through the second end cap 520 is attached to the right side of the yoke module 575. In such as implementation, the actuator stroke causes anti-clockwise rotation of the yoke 590 (when viewed from top) and the actuator stroke reversal causes clockwise rotation of the yoke 590 (when viewed from top). In other words, the actuator's body 505 (hydraulic/pneumatic module) and/or spring module 593 may be disassembled from the actuator body yoke module 575 in situ without removing or opening the top cover of the yoke module 575 or the yoke module 575 itself from the valve or pipeline while still maintaining the integrity of the ingress protection of the actuator. That is to say, without removing the actuator from the pipeline.

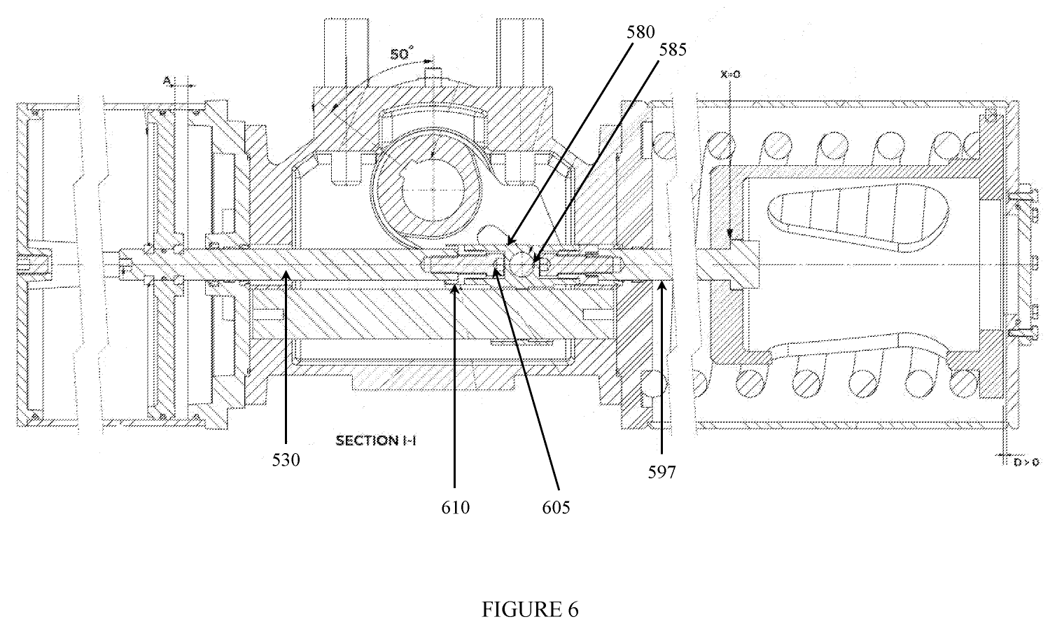

In one embodiment of the present disclosure, a mechanism is provided for absorbing any misalignments (radial, axial and angular) induced due to tolerance stack up during manufacturing and any misalignment induced due to deflections caused by the scotch mechanism during operation of the rotary scotch yoke fluid power actuator. FIG. 6 illustrates a rotary scotch yoke fluid power actuator with multi-misalignment absorption mechanism in accordance with an embodiment of the present disclosure. As shown, the multi-misalignment absorption mechanism comprises a bolt 605 (bolting mechanism) and a free nut 610, wherein the bolt 605 and the free nut 610 connects the piston rod 530 and the spring rod 597. The free nut 610 is screwed into the guide block 580 and the piston rod 530 and the spring rod 597 are connected through the free nut 610 and bolt 605. Such arrangement absorbs any misalignment (radial, axial and angular) induced due to the tolerance stack up during the manufacturing and misalignment induced due to deflections caused by the scotch yoke mechanism during the operation, thereby eliminates any side loads exerted between the cylinder, the spring module and the yoke module.

As described, the fluid power actuators disclosed in the present disclosure comprises at least one hollow tie rod, disposed inside the cylindrical cavity, for conveying a pressurized fluid from one side of the piston to the other side of the piston. Such arrangement eliminates the need of external tubing, and eliminates the use of drilled, tapped holes in end cap and reduces the number of fittings for stroke reversal in linear and scotch yoke rotary fluid power actuators. In addition, the fluid power actuators disclosed in the present disclosure eliminates the problems associated with external fittings and tubing.

Further, the internal hollow tie rods are configured for holding the two end caps to the actuator body. Hence, the fluid power actuators having the hollow tie rod along with one or more tie rods inside the cylindrical cavity holds the pressure retaining cylinder assembly (cylinder, two end caps and the piston).

Furthermore, the two ports are formed on one of the end caps and hence compact direct mounted direction control valves such as NAMUR valves may be used with the fluid power actuators disclosed in the present disclosure.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. A fluid power actuator (300) comprising:
an actuator body (305) having a cylindrical cavity (310), wherein a major axis of the cylindrical cavity (310) is substantially parallel to a longitudinal axis of the actuator body (305), wherein the actuator body (305) is fitted with a first end cap (315) and a second end cap (320) at longitudinal ends of the actuator body (305) and a piston (325) with a piston rod (330) disposed inside the cylindrical cavity (310), the piston (325) being free to move along the longitudinal axis of the cylindrical cavity (310), wherein the actuator (300) is further characterised by:
a hollow tie rod (335) in the cylindrical cavity (310), wherein the hollow tie rod (335) is used for conveying a pressurised fluid into a volume (A) in the cylindrical cavity (310) between the second end cap (320) and the piston (325) for exerting a force on the piston (325) for one of a stroke and a stroke reversal.

2. The fluid power actuator (300) as claimed in claim 1, wherein a first end (340) of the hollow tie rod (335) is screwed to the first end cap (315) and passes through the first end cap (315), and a second end (345) of the hollow tie rod (335) is fastened to the second end cap (320) with a nut (N1) for holding the two end caps (315 and 320) to the actuator body (305).

3. The fluid power actuator (300) as claimed in claim 2, wherein the first end (340) of the hollow tie rod (335) is coupled to a first port (T1), the first port (T1) being configured for feeding the pressurised fluid through hollow tie rod (335), into the volume (A) in the cylindrical cavity (310) between the second end cap (320) and the piston (325), and for draining the pressurised fluid from the volume (A) between the second end cap (320) and the piston (325).

4. The fluid power actuator (300) as claimed in claim 1, wherein the first end cap (315) comprises a second port (T2) configured for feeding the pressurised fluid into a volume (B) in the cylindrical cavity (310) between the first end cap (315) and the piston (325), and for draining the pressurised fluid from the volume (B between the first end cap (315) and the piston (325).

5. The fluid power actuator (300) as claimed in claim 1, wherein the fluid power actuator (300) comprises one or more tie rods (350) inside the cylindrical cavity (310), in addition to the hollow tie rod (335), for holding the two end caps (315 and 320) to the actuator body (305).

6. The fluid power actuator (300) as claimed in claim 5, wherein a first end (355) of each of the one or more tie rods (350) is screwed into the first end cap (315) and a second end (360) of each of the one or more tie rods (350) is fastened to the second end cap (320) with a nut (N2) for holding the two end caps (315 and 320) to the actuator body (305).

7. The fluid power actuator (300) as claimed in claim 1, wherein the fluid power actuator (300) is a linear actuator.

8. The fluid power actuator (300) as claimed in claim 7, further comprising a spring (465) disposed in the cylindrical cavity (310) between the first end cap (315) and the piston (325), for causing the movement of the piston (325) towards second end cap (320) for extension of the piston rod (330).

9. The fluid power actuator as claimed in claim 7, further comprising a spring disposed in the cylindrical cavity (310) between the second end cap (320) and the piston (325), and the expansion of the spring causes retraction of the piston rod (330).

10. The fluid power actuator as claimed in claim 7, wherein the second end cap (320) is covered with an end plate (365) for concealing the second end cap (320) so as to restrict access to the nuts N1.

11. The fluid power actuator as claimed in claim 1, wherein the fluid power actuator is a rotary scotch yoke fluid power actuator (500A and 500B).

12. The fluid power actuator as claimed claim 11, wherein the force exerted on the piston (525) for one of the stroke and the stroke reversal is transferred to a yoke (590) through a guide block (580) and a yoke pin (585) of a yoke module for converting a linear motion to a rotary motion of the yoke (590) in one of a clockwise direction and an anti-clockwise direction.

13. The fluid power actuator as claimed in claim 12, wherein the force exerted on the piston (525) for the stroke is transferred to a spring rod (597) of a spring module (593), through the piston rod (530) and guide block (580), for compressing a spring (595) disposed in a spring module (593) and storing a potential energy in the spring (595) and for causing the yoke (590) to rotate in the clockwise direction.

14. The fluid power actuator as claimed in claim 13, wherein an expansion of the spring (595) is used for exerting a force on the yoke pin (585) through the spring rod (597) and the guide block (580), for causing the yoke (590) to rotate in the anti-clockwise direction.

15. The fluid power actuator as claimed in claim 14, wherein the force is transferred to the piston rod (530), through the spring rod (597) and the guide block (580), for causing an extension of the piston rod (530).

16. The fluid power actuator as claimed in claim 13, wherein the spring module (593) is detachably coupled to the actuator via the yoke module (575) and the actuator body (505) is detachably coupled to the yoke module (575), wherein the position of the spring module (593) and the yoke module (575) is interchangeable, in situ, without removing or opening the actuator.

17. The fluid power actuator as claimed in claim 13, wherein the piston rod (530) and the spring rod (597) are connected through the guide block (580) using a bolt (605) and a free nut (610) for absorbing a misalignment.
